(19) United States
(12) Patent Application Publication
(10) Pub. No.: US 2026/0368327 A1
(43) Pub. Date: Nov. 19, 2026

(54) METHODS AND SYSTEMS FOR SECURE ENCLAVES FOR BOOT READ-ONLY-MEMORY

(71) Applicant: Ambiq Micro, Inc., Austin, TX (US)

(72) Inventor: Jayesh SHAH, Austin, TX (US)

(21) Appl. No.: 19/668,531

(22) Filed: May 5, 2026

Related U.S. Application Data
(60) Provisional application No. 63/807,301, filed on May 16, 2025.

(51) Int. Cl. G06F 21/57; G06F 21/53; G06F 21/64

(52) U.S. Cl. CPC G06F 21/572; G06F 21/53; G06F 21/64

(57) ABSTRACT

Methods and systems for augmenting the functionality of a boot read-only-memory (ROM) of a system-on-chip are disclosed. The system-on-chip includes a boot ROM that has executable boot code. The system-on-chip also includes a secure enclave that stores a blob of executable code downloaded to the system-on-chip. The blob of executable code downloaded to the system-on-chip is accessible when the boot ROM is executed. In some examples, the blob of executable code is encrypted and packaged as an over-the-air (OTA) update. When the blob of executable code is downloaded by the system-on-chip, it can be processed and loaded as a library accessible to the boot ROM.

### CROSS-REFERENCE TO RELATED APPLICATIONS

This application claims priority to, and benefit of, U.S. Provisional Patent Application No. 63/807,301, filed on May 16, 2025, and titled “SECURE ENCLAVE FOR BOOTROM,” which is hereby incorporated by reference herein in its entirety.

### TECHNICAL FIELD

The present invention relates generally to system-on-chip microcontrollers. More particularly, aspects of the present disclosure relate to a secure enclave that may augment or supplement secure program execution from read only memory (ROM).

### BACKGROUND

In recent years, due to the growth of portable electronics, there has been a push to decrease the power used by microcontrollers (or “MCU”), microprocessors, application processors, digital signal processors (DSPs), neural processing units (NPUs), and other circuits used in portable electronic appliances. With lower power requirements, effective electronics operation time can be extended, or alternatively, smaller batteries can be used. Commonly, the power consumption of a microcontroller and associated circuits may be reduced by using a lower supply voltage, or by reducing the amount of internal capacitance being charged and discharged during the operation of the circuit.

One method for reducing microcontroller power relies on hardware or software-based power mode switching. Power modes can be selected for microcontroller components or resources based on operating state, operating conditions, and/or sleep cycle characteristics and other factors to configure low power modes for selected microcontroller components at the time the processor enters a low power or sleep state. In some systems, a set of predefined low power configurations can be used, while more sophisticated systems can dynamically select low power configurations to maximize power savings while still meeting system latency requirements.

Modern system-on-chips (SoCs) rely on immutable boot ROM as a security root of trust. Apart from being immutable, and hence fully trusted, secure boot ROM in a SoC can be designed to have unique privileges. In some SoCs, the boot ROM is designed to store execute-only code, and hence the executable code is not visible, and cannot be stepped through except during the chip manufacturing life cycle before provisioning the device. This allows the boot ROM code to have embedded secret data (either explicit keys, or secret procedural mechanisms) without the risk of exposure. Moreover, a SoC can be designed to have temporal attributes relating to security. Thus, certain resources or privileges are only allowed during the secure boot phase and locked out afterwards. These design elements give boot ROM unique privileges and the ability to execute code to perform functions that are impossible otherwise.

However, boot ROM is synthesized as a part of the SoC and hence is not updatable. It is not possible to modify or insert new functionality on the boot ROM after the SoC has been manufactured. This provides limitations to the use of boot ROM. The present disclosure provides a solution for this and other problems.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a system-on-chip is disclosed. The system-on-chip includes a boot read only memory (ROM) that includes executable boot code. The system-on-chip also includes a secure enclave that stores a blob of executable code downloaded to the system-on-chip. The blob of executable code downloaded to the system-on-chip is accessible when the boot ROM is executed.

According to one aspect of the present disclosure, the blob of executable code can be received via a wireless interface.

According to a configuration of the above implementation, the blob of executable code can be received via a wired interface.

According to another configuration of the above implementation, the blob of executable code is encrypted and signed.

According to a further configuration of the above implementation, the secure enclave is stored in static random access memory (SRAM).

In a further aspect of the above implementation, the secure enclave is used to augment the functionality of the boot ROM.

In yet a further aspect of the above implementation, the system-on-chip includes a one-time-programmable (OTP) device. The OTP device includes one or more trim values. The blob of executable code, in turn, includes instructions to modify at least one of the trim values and augment the functionality of the boot ROM once when the boot ROM is executed.

According to a configuration of the above implementation, the functionality of the boot ROM is augmented each time the boot ROM is executed.

According to another configuration of the above implementation, the blob of executable code includes an entry function. The entry function can accept an input parameter.

According to a further configuration of the above implementation, the executable boot code of the boot ROM can include instructions to call the entry function and provide the input parameter. This can be used to augment the functionality of the boot ROM.

In a further aspect of the present disclosure, a method is disclosed. The method includes receiving, at a secure enclave of a system-on-chip, a blob of executable code. After a reset of the system-on-chip, a boot process of the system-on-chip is started. The boot process includes starting an execution of executable boot code stored on a boot ROM. The execution of the boot ROM includes processing the received blob of executable code. The processed blob is then loaded into a memory of the system-on-chip as a library accessible by the boot ROM.

According to another configuration of the above implementation, processing the blob of executable code further includes decrypting the encrypted blob. The decrypted blob is then verified.

According to another aspect of the above implementation, the method further includes checking for a presence of the blob of executable code as part of an update checking protocol. The update checking protocol can be executed after a reset of the system-on-chip is started.

In another aspect of the above implementation, the execution of the boot ROM includes identifying if the blob is associated with a function update to the boot ROM. This can be done based on one or more keys associated with the blob.

In another configuration of the present disclosure, the blob includes an entry function. The execution of the boot ROM may include dynamic linking with the executable blob as a library, providing an input parameter to the entry function. This can grant the library a superuser access to the system-on-chip. The method may further include executing one or more functions included in the library.

In yet a further aspect of the above implementation, the execution of the boot ROM further includes performing a boot ROM exit upon a completion of one or more functions included in the library. The boot ROM exit may include a cleanup of the memory of the system-on-chip where the blob of executable code is stored.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be better understood from the following description of exemplary embodiments together with reference to the accompanying drawings, in which:

FIG. 1 is a diagram of an example system-on-chip in an energy efficient device requiring near threshold voltages for various components;

FIG. 2 is a block diagram of the example system-on-chip in FIG. 1;

FIG. 3 is a flow diagram of an example boot ROM flow along with the augmentation routine, according to certain aspects of the present disclosure;

FIG. 4 is a diagram of a structure of an example binary blob, according to certain aspects of the present disclosure; and

FIG. 5 is a flow chart of an example method for augmenting a boot ROM of a system, according to certain aspects of the present disclosure.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure is directed toward an example method to dynamically enhance boot ROM on a system-on-chip by allowing the addition of new functionality after production of a device using the system-on-chip. The new functionality may either be the addition of a one-time action or updates to be executed as part of every boot of the system-on-chip. The functionality of the boot ROM is expanded by an example expandable secure enclave in the root of trust. The secure executable could be temporarily stored in a volatile memory such as a random access memory (RAM), or installed permanently in a non-volatile memory to augment the secure boot ROM.

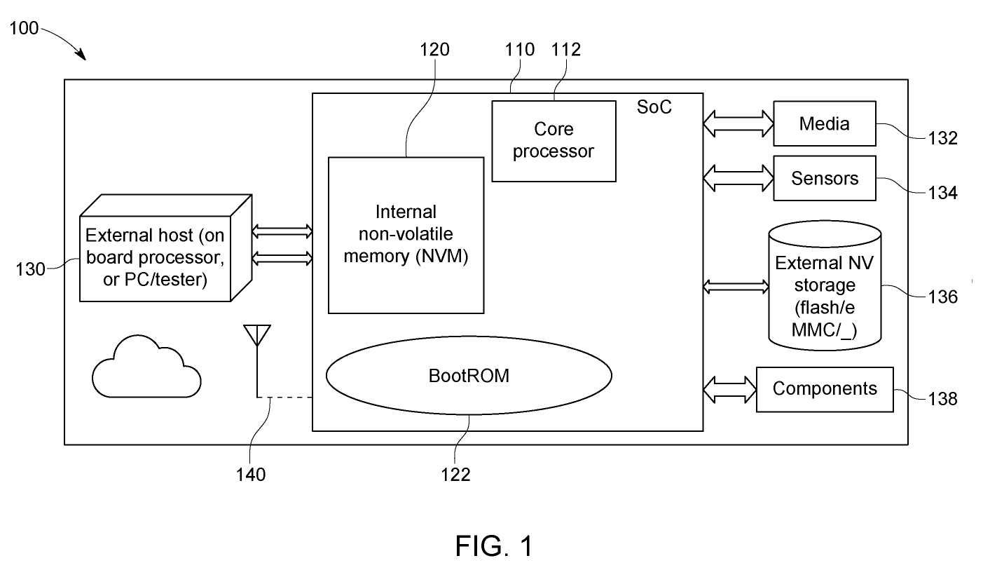

FIG. 1 shows a block diagram of a device 100 with a system-on-chip 110. The system-on-chip 110 includes a core processor 112 and non-volatile memory 120 that is a magneto-resistive RAM (MRAM). The system-on-chip 110 also includes permanent memories such as a read only secure boot read only memory (ROM) 122. In this example, the system-on-chip 110 is installed in the device 100 and the core processor 112 executes applications generally stored in the non-volatile memory 120 to operate the device 100 to perform different functions.

The system-on-chip 110 may include an external host 130 that controls the functions of the system-on-chip 110, which may be connected via wired interfaces such as UART, SPI, or I2C interfaces. The system-on-chip 110 controls and accesses a set of components on the device 100 that may include media devices 132 such as a display or an audio output, sensors 134, a non-volatile (NV) memory device 136 such as MSPI Flash or eMMC, or other components 138. As will be explained the NV memory device 136 serves as an alternate storage device for storing a recovery image. The external host 130 could be coupled to a wireless interface 140 such as Bluetooth or Wi-Fi that allows communication with external components to the device 100. A battery 150 provides power to the components of the device 100 including the system-on-chip 110.

Although not all the electronic components illustrated in FIG. 1 may be operable in the sub-threshold or near-threshold domains in any particular embodiment, some, at least, may be advantageously adapted to do so, with concomitant reductions in system power dissipation.

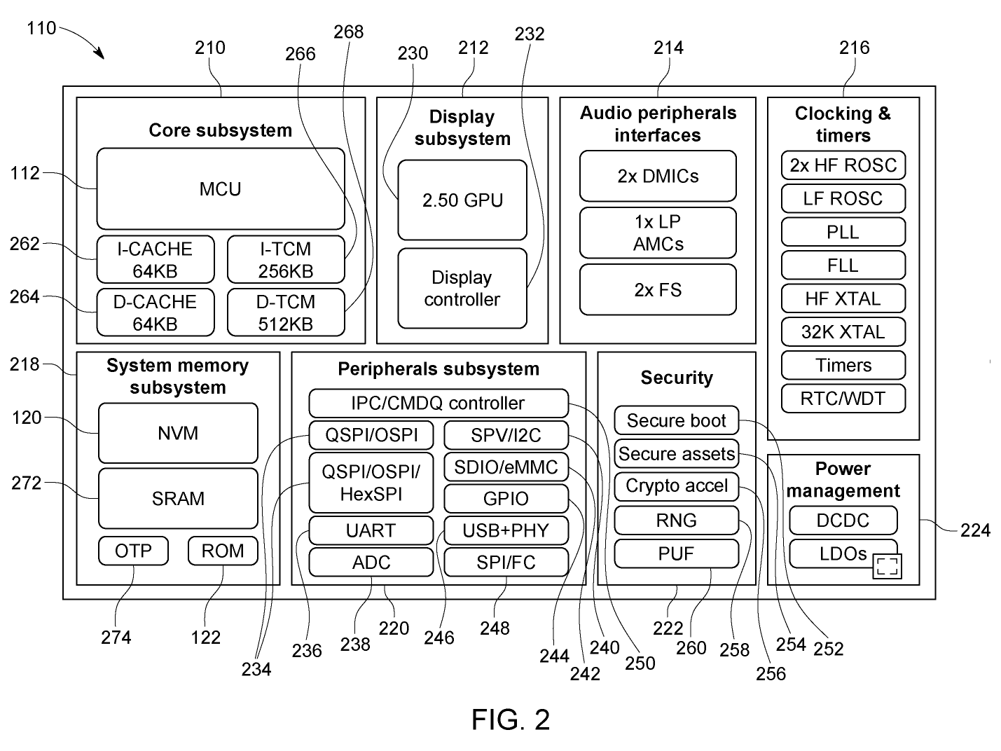

FIG. 2 shows a block diagram of the system-on-chip 110 in FIG. 1. The system-on-chip 110 includes a core subsystem 210, a display subsystem 212, an audio peripherals subsystem 214, a clocking and timers subsystem 216, a memory subsystem 218, a peripheral subsystem 220, a security subsystem 222, and a power management subsystem 224. The display subsystem 212 includes a graphic processor 230 and a display controller 232 to drive displays on the device 100. The audio peripherals subsystem 214 includes different audio peripheral interfaces for driving audio components on the device 100. The clocking and timers subsystem 216 includes timers and clocks for the system-on-chip 110.

The peripheral subsystem 220 includes different interfaces such as QSPI/OSPI/HexSPI interfaces 234, UART interfaces 236, analog to digital converters 238, SP/I2C master interfaces 240, SDIO (Secure Digital Input Output)/MMC (Multi-Media card) interfaces 242, a set of general purpose input/output (GPIO) pins 244, a USB interface 246, and a SPI slave interface 248. The peripheral interfaces are managed by a peripheral controller 250 that manages inter process communication (IPC) and a command queue (CMDQ). The security subsystem 220 includes a secure boot 252, security assets 254, a crypto accelerator 256, a random number generator (RNG) 258 and a physical unclonable function (PUF) 260. The power management subsystem 224 includes power sources such as low drop out (LDO) and DC power regulator supply sources.

The core subsystem 210 includes the core processor 112 that may be any suitable processor, microcontroller, and the like. In this example, the core processor 112 is an ARM Cortex MCU, but any suitable programmable controller or processor may be used. The core subsystem 210 includes an instruction cache 262 and a data cache 264. The core subsystem 210 includes an instruction tightly controlled memory (TCM) 266 and a data TCM 268. The memory subsystem 218 includes synchronous static random access memory (SRAM) 272, a one-time programmable (OTP) device 274, and the boot read only memory (ROM) 122. In this example, the OTP device 274 is an e-fuse. The OTP device 274 stores data, such as trim values, that may written during production testing and is read by the core processor 112 for tuning components such as the example adaptable voltage converter. The memory subsystem 218 also includes the non-volatile memory 120, which is MRAM in this example.

The power management subsystem 224 includes voltage converters to provide power to the components of the system-on-chip 110. The power management subsystem 224 provides voltage to both digital modules such as the core subsystem 210 and analog modules such as the clocking and timers subsystem 216 and analog to digital converters (“ADC”) in the peripheral subsystem 220, and the like. The power management subsystem 224 includes reference voltage generators and reference current generators. In some example embodiments, the power management subsystem 224 includes low drop-out (LDO) voltage regulators. The LDO regulators supply power to processor cores of the core processor 112 and volatile memory devices of the memory subsystem 218. The reference voltage generator and reference current generator are each common modules for supplying a stable reference signal to analog modules on the chip 110. The reference voltage generator is sometimes used to derive the output reference current provided by reference current generator.

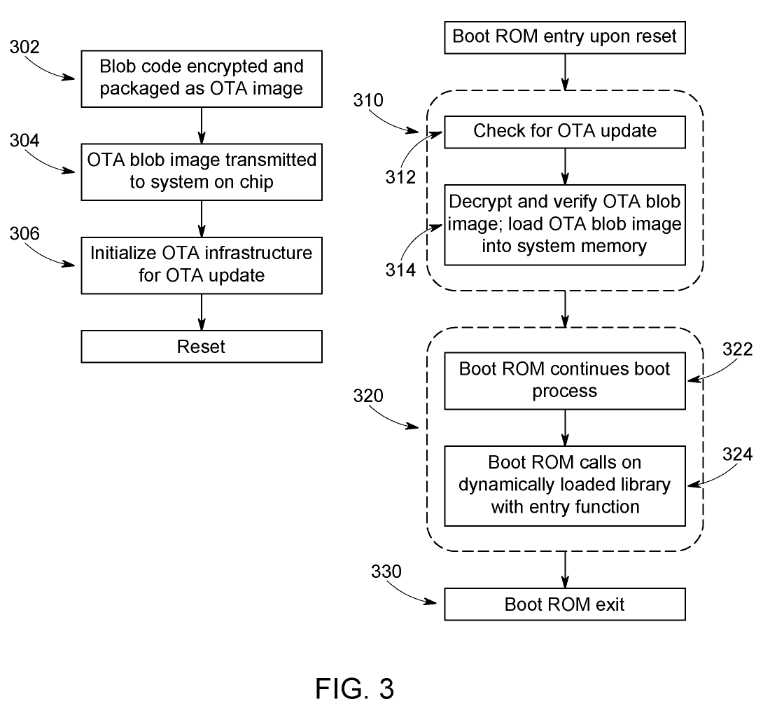

FIG. 3 is a flow diagram of an example boot ROM augmentation routine, according to certain aspects of the present disclosure. In this example, a boot ROM stored in the ROM 122 of the system-on-chip 110 may be dynamically enhanced via an expandable secure enclave in the root of trust. The new function is implemented as a position independent state-less library, with a single entry point function. The entry point function is a function that may be called as part of the execution of instructions stored in the boot ROM in the ROM 122 of the system-on-chip 110. When called, the entry point function can take an input parameter as a generic structure that gives it access to state space of the caller. This gives the entry point function access to the state space of the boot ROM. The entry point function also transfers control of the program flow of the system-on-chip 110 to the expandable secure enclave. For example, the core processor 112 may execute the instructions stored in the boot ROM as part of a boot process of the system-on-chip 110. When the core processor 112 executes the entry function, the program flow of the core processor 112 is transferred to the secure enclave, which contains a library that augments a function or functions of the boot ROM. In some example embodiments, the execution of the boot ROM has superuser or administrator privileges to the device 100 or the system-on-chip 110. These superuser or administrator privileges may be a level of privilege that gives the core processor 112 of the system-on-chip 110 full access to all rights and permissions of the system-on-chip 110 or the device 100 during execution of the boot ROM. The input parameter to the entry point function may be a pointer parameter passed to the function that allows the entry point function full access to the operation context of the boot ROM. The operational context of the boot ROM is the operational context of the ROM 122 that the boot ROM is stored in. The operational context may include the instructions included in the boot ROM, the data included in the boot ROM, or the memory and devices of the system-on-chip 110 affected by the operations encoded in the instructions of the boot ROM. Other data associated with the boot ROM may be included in the operation context of the boot ROM. By allowing the boot ROM to access the encrypted secure library stored in the memory of the system-on-chip 110, such as the non-volatile memory 120 or the external NV memory device 136, the boot ROM may extract the secure enclave to memory of the system-on-chip 110. This secure enclave allows for the secure augmentation of the capabilities of the boot ROM. The flow begins at block 302.

At block 302, the blob code is encrypted and packaged as an over-the-air (OTA) image. This may occur at an external system, such as the external host 130 shown in FIG. 1. The external host can be a computing system or computing server that can create a blob of executable code intended to be distributed as an OTA update for a boot ROM of the system-on-chip 110. In some example embodiments, the external host may encrypt and sign the blob when processing the blob to create an OTA image. In this example, the binary object code is then encrypted, signed and packaged as an over the air (OTA) image using secret keys. A header is added as part of packaging of the blob to add metadata information identifying keys (in case of more than one possible option), as well as location of the entry function within the binary blob. This process may additionally include modifying the blob code to include signatures and public keys that allow for the system-on-chip 110 to identify, decrypt, and verify the OTA image upon receipt.

At block 304, the OTA blob image is transmitted to the system-on-chip 110. The blob may be transmitted via a wired or wireless communications network. For example, the OTA blob image may be transmitted via a communications network such as the internet to the system-on-chip 110. The system-on-chip 110 may be communicatively coupled with the external host that created the OTA blob image via the communications network. In some examples, another external computing system may create the OTA blob image. The external computing system may be communicatively coupled with the external host, which may then transmit the OTA blob image to the system-on-chip 110 via a communications network. Other over-the-air methods using Bluetooth, BLE, Wi-Fi or other wireless protocols can be used by the resident main application, or in some cases by the on-chip bootloader. Alternatively, the blob may be transferred using wired interfaces such as UART, SPI, I2C, USB and the like. The blob could be downloaded either to volatile memory such as TCM or SRAM, or to a non-volatile memory like MRAM.

The OTA blob image may also be packaged by one or more processors of a computing system that is communicatively coupled with the external host. In some embodiments, the system-on-chip 110 may be installed in this computing system.

At block 306, the OTA infrastructure is initialized for the OTA update. This can include an application running on the core processor 112 or a bootloader of the system-on-chip 110 initializing the OTA infrastructure with information about a pending OTA update and resetting the device. For example, the OTA infrastructure of the system-on-chip 110 may be initialized to receive and install the OTA blob image. In some example configurations, such as those that utilize the Apollo5 SoC OTA infrastructure, there can be special identifiers in the OTA image blob that distinguish the image type from other possible OTA images. In the example embodiments that use an Apollo5 SoC, the information includes an OTAPOINTER register that stores information about the address of the OTA image. This may include, but is not limited to, identifying space in memory to load the OTA image blob, receiving the OTA image blob into a memory of the system-on-chip 110, and preparing a one-time-programmable (OTP) device to store the OTA image blob.

Initializing the OTA infrastructure may also include executing a reset procedure of the system-on-chip 110 and/or the device 100 that is operably coupled with the system-on-chip 110. The reset procedure can include powering off the core processor 112 of the system-on-chip 110, powering off other components of the system-on-chip 110, and/or powering off the system-on-chip 110 itself.

The reset procedure may be configured to enter a boot ROM upon reset. Upon reset, the core processor 112 starts execution from boot ROM as part of the immutable root of trust. The boot ROM may be a part of the system-on-chip 110 that includes machine-readable instructions. When the boot ROM is entered, the core processor 112 of the system-on-chip 110 can read the machine-readable instructions of the boot ROM. The machine-readable instructions, when executed upon the execution of boot process of the system-on-chip 110, may cause the core processor 112 and other components of the system-on-chip 110 to execute operations that implement the boot process of the system-on-chip 110. The boot process can include initializing parameters associated with the components of the system-on-chip 110, initializing application processes and bootloaders of the system-on-chip 110, and executing boot functions included in the machine-readable instructions of the boot ROM stored in the ROM 122. The boot process may also include a series of hardware initialization operations including: (a) configuration of clock generation circuits to establish system timing references; (b) initialization of memory controllers for external volatile memory devices; (c) configuration of input/output controllers for peripheral device communication; (d) establishment of interrupt vector tables; and (e) testing of critical system components for the system-on-chip 110.

The operations performed as part of the execution of the instructions in the boot ROM also include checking the OTA infrastructure for the OTA blob image and installing the OTA blob image, as shown in stage 310. Stage 310 includes block 312 and block 314.

At block 312, the system checks for an OTA update. After basic system initialization, the boot ROM then checks for pending OTA updates as per the well-defined OTA update protocol understanding between the application/bootloader and the boot ROM. For example, as described above, the core processor 112 of the system-on-chip 110 may check for an OTA update using the OTA infrastructure. This process may also include checking a signature of the OTA image blob to identify it as an OTA update. Checking for an OTA update may be executed as part of the instructions included in the boot ROM. The instructions may be performed one or more times, or in a loop.

At block 314, the OTA blob image is decrypted, verified, and loaded into system memory. The memory may be the non-volatile memory 120 of the system-on-chip 110 or the SRAM 272 of the system-on-chip. The OTA blob image may include one or more signatures, keys, or other functions. The core processor 112 of the system-on-chip 110 can perform the decryption and verification based on the signatures and keys included in the OTA image blob. As part of processing of the OTA blob previously downloaded in the OTA update process, the core processor 112, executing instructions included in the boot ROM, performs necessary decryption and verification of the OTA image blob stored in on chip memory such as the external non-volatile memory device 136 in FIG. 1. In some example configurations, the OTA image blob may be stored in the SRAM 272 of the system-on-chip 110. A successfully verified blob is inspected for the special identification distinguishing the blob as a function update, as compared to an update image for the on-chip assets. The image may also be stored in any memory accessible to the boot ROM such as non-volatile memory 120, SRAM 272, or an external memory device such as the NV memory device 136. In these cases, decrypting the OTA blob image may include loading the decrypted version of the OTA blob image into the SRAM 272, non-volatile memory 120, external NV memory device 136, or any other memory accessible to the boot ROM.

In one example configuration using an Apollo5 Soc, the system uses the OTAPOINTER value to identify a pending update to be processed. Upon finding a valid update image, the system uses RSA based authentication to validate the update image. Once authenticated, the system uses AES decryption to output a cleartext image. The Secure Enclave update is identified using a signature, and upon successful processing, the header field “patch function offset” is used to identify the address of the embedded function that the boot ROM then invokes as part of an execution flow of the boot process defined by the instructions included in the boot ROM. In some examples, the signature is a unique signature that may only be used once during a secure enclave update. In other examples, the signature is unique to each update image.

Block 314 also includes loading the OTA blob image into system memory. As explained above, the decrypted and verified OTA blob image can be loaded into any memory accessible to the boot ROM such as the SRAM 272, the non-volatile memory 120, or the external NV memory device 136. In some example configurations, the system-on-chip 110 is communicatively coupled with a one-time-programmable (OTP) device such as the OTP device 274. The OTP device can be loaded with the decrypted and verified OTA blob. In some examples, the OTP device 274 loaded with the decrypted and verified OTA blob is used as a permanent update or patch for the boot ROM. Every time the system-on-chip 110 boots, the OTP device 274 loaded with the decrypted and verified OTA blob is executed, augmenting the functionality of the boot ROM.

In some example embodiments, loading the OTA blob image into system memory includes compiling the Secure Enclave code to generate a compiled OTA blob image. The instructions included in the compiled Secure Enclave image may be executed by the core processor 112 of the system-on-chip 110. Depending on the compiler used, there are different means to achieve this. The compiler may be executed by a remote server communicatively coupled to the system-on-chip 110, or generated on a separate machine and then loaded on to the remote server. In an example configuration, a compiler such as ARM® Clang is used alongside development tools, such as ARM® Keil μVision. In this example configuration, the decrypted and verified OTA blob image is compiled as a position independent library using the option “Read-Only Position Independent.” Other development tools, compilers, and compilation techniques may also be used to compile the OTA blob image into a library to expand the functionality of the boot ROM.

In yet a further example configuration, the compiled OTA blob image is then used to create a binary OTA blob image to be loaded into memory accessible by the boot ROM. For example, once the OTA blob image is compiled, tools such as objcopy may be used to create a raw binary image representing the executable code. The resultant binary is also disassembled using tools such as objdump or fromelf to identify the offset of the entry function in the binary OTA blob image. This binary OTA blob image is then loaded into memory accessible by the boot ROM, allowing for the boot ROM to access the binary OTA blob image and execute operations based on the raw binary code of the binary OTA blob image.

The decrypted, verified, and successfully loaded blob can be treated as a dynamically loaded library, with an entry function. The entry function is then called as a regular function call by the boot ROM.

Stage 320 describes processes of the system-on-chip 110 associated with utilizing the expanded functionality provided by the successfully loaded OTA blob image. As described above, the loaded blob can be treated as a dynamically loaded library accessible via a function call by the boot ROM.

At block 322, the execution of the boot ROM is continued. For example, the core processor 112 of the system-on-chip 110 can continue executing the boot process instructions stored in the boot ROM. These instructions can include further hardware initialization operations, parameter initialization operations, and other boot operations.

At block 324, the execution of the boot ROM calls on the dynamically loaded library with an entry function. As described above, the loaded blob can be treated as a dynamically loaded library accessible via a function call by the boot ROM. The object code included in the secure enclave extracted from the OTA blob includes the entry function, which may be executed by the core processor 112 of the system-on-chip 110. Executing the entry function transfers control of the program flow of the core processor 112 of the system-on-chip 110 to the loaded blob image. Thus, the blob can act as a logical extension to the boot ROM, granting the blob the same superuser privileges within the secure boot program flow before temporal restrictions are placed on user privileges of the system-on-chip 110 upon boot ROM exit. Once the function returns, the rest of the boot ROM functionality resumes. Since the loaded blob image has access to full state space of boot ROM, the loaded blob image can also include instructions that modify the instructions and data included in the boot ROM when executed by the core processor 112.

In some example configurations, this functionality can be used to implement one-time processing. Such processing may include programming and/or updating an on-chip trim space of the system-on-chip 110 or on-chip OTP bits (e.g., for enabling/disabling features, to revoke keys, or to augment certain event triggered functionality that requires loading and processing an OTA blob by the boot ROM). The same mechanism could also be used to permanently augment the boot ROM functionality by placing the blob in a predefined location in non-volatile memory. The non-volatile memory may then be inspected by the boot ROM during execution of the boot process, ensuring that the boot ROM functionality is permanently augmented by the blob. When the blob is found in the non-volatile memory, an additional function call may be added to the boot ROM and/or the loaded blob image to invoke the library implemented by the loaded blob image for every boot.

At block 330, the execution of the boot ROM is completed. Upon successful completion of hardware initialization routines, the core processor 112 of the system-on-chip 110 may transfer control of the program flow of the core processor 112 from the operational context of the boot ROM to secondary boot loaders or operating system kernels stored in external memory devices, thereby completing the boot ROM execution. As part of the boot ROM exit, the memory such as SRAM 272 where the blob is decrypted is cleaned up to ensure no sensitive code or data is exposed.

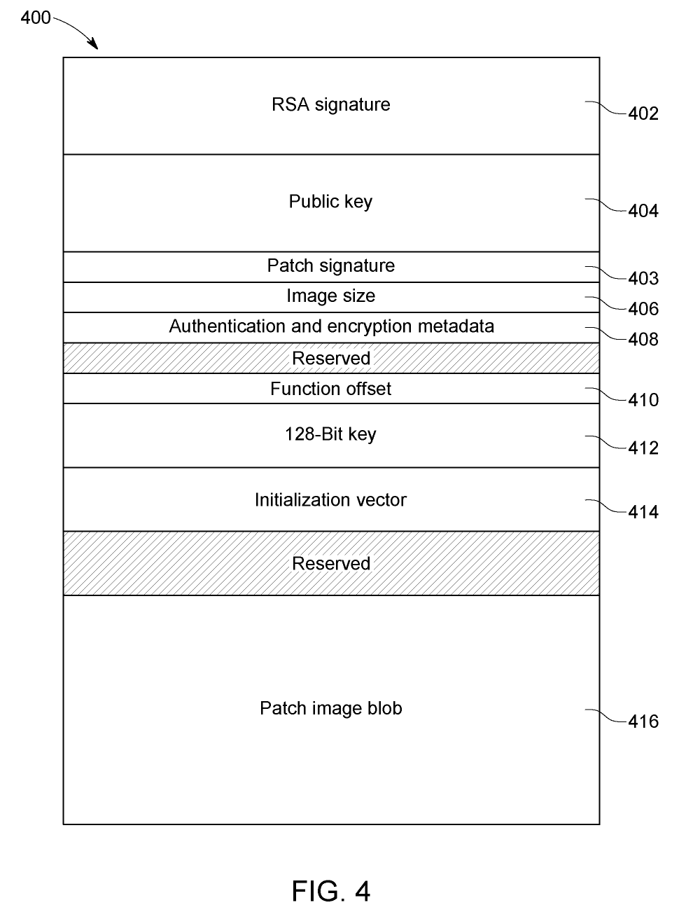

FIG. 4 is a diagram of a structure of an example blob 400, according to certain aspects of the present disclosure. FIG. 4 shows details of the blob 400 that is sent to the system-on-chip 110. Before processing, the blob 400 can be a binary blob, a processed blob, or an encrypted and signed blob. The blob 400 can also be formatted according to a formatting protocol for OTA updates. For example, the blob 400 can be a generic Apollo5 OTA blob image processed by the boot ROM of the Apollo5 SoC. The blob 400 includes an RSA signature block 402, a patch signature block 403, a public key block 404, an image size block 406, an authentication and authorizations block 408, and a function offset 410.

The RSA signature block 402 is generated during authentication processing of the blob 400. For example, the system-on-chip 110 may use the public key block 404 to compute a signature that is compared with a signature included in the RSA signature block 402. By comparing the generated signature and the RSA signature block 402, the blob may be verified by the system-on-chip 110.

The patch signature block 403 distinguishes the secure-enclave patch update from other OTA images. For example, the patch signature block 403 may include a signifier, code, or other information that distinguishes the blob 400 from other OTA images. The patch signature block 403 can also include information that indicates that the blob 400 is a functional update, as opposed to another type of OTA update. For example, the patch signature block 403 can include information associated with the functions included in the blob 400. This information could describe the functions that the blob 400 is intended to extend the functionality of the boot ROM with.

Blob 400 also includes additional header information that includes metadata associated with the blob 400 as part of packaging. An Authentication and Encryption Metadata header in the authentication and encryption block 408 is added to add metadata information identifying keys. The authentication and encryption metadata can include metadata identifying one or more keys where the blob 400 includes/uses a plurality of public and/or private keys. The function offset 410 is a field or parameter within a patch image 416 that identifies an address of the entry function in a memory of the system-on-chip 110 or the device 100 that the system-on-chip 110 is operably coupled with. In some examples, the function offset 410 identifies an offset within the decrypted blob 400. The patch image blob 416 includes the code and data characterizing the operations that the blob 400 is intended to augment the functionality of the boot ROM of the system-on-chip 110 with. When read during the execution of the operations encoded in the boot ROM, the function offset 410 can direct the program flow of the operations encoded in the boot ROM to the address of the entry function, allowing the entry function to be called and the program flow to be moved to the address space of the blob 400 in a memory of the system-on-chip 110 or the device 100 that the system-on-chip 110 is operably coupled with.

The public key block 404 can include one or more public keys associated with an encryption scheme applied to the blob 400. The public keys included in the public key block 404 can be public keys for the encrypted blob 400. During the creation, encryption, and signing of the blob 400, the blob code of the blob 400 is encrypted and packaged as an OTA image. This may occur at an external system such as the external system 130. The external host can be a computing system or a computing server that can create a blob of executable code intended to be distributed as an OTA update for a boot ROM of the system-on-chip 110. In this example, the binary object code is then encrypted, signed and packaged as an over the air (OTA) image using secret keys. Public keys can also be included in the blob 400 in the public key block 404. The public key block 404 can be structured in accordance with RSA based encryption techniques or other encryption protocols.

When the blob 400 is received by the system, the public key block 404 can be read. For example, the core processor 112 of the system-on-chip 110 can read the public key block 404 to receive one or more public keys. The core processor 112 of the system-on-chip 110 first verifies the public key using a root of trust of the core processor 112 and/or the system-on-chip 110. The core processor 112 of the system-on-chip 110 may also use other roots of trust or other techniques to verify the public key. Thereafter, it uses the public key to authenticate the blob 400 by generating a signature and comparing with the blob signature 402. After successful authentication, blob 400 may then be decrypted. In some example embodiments, at least one of the one or more public keys included in the public key block 404 may be used by the core processor 112 of the system-on-chip 110 to authenticate blob 400. Information embedded in the Metadata 408 is used to verify the public key 404 itself. In some example configurations, the core processor 112 can decrypt the blob 400 using decryption techniques such as AES based decryption using symmetric secret keys, as identified by the Authentication and Encryption metadata in the block 408.

The image size block 406 includes information associated with the total size of the blob 400. The blob 400 may be signed. If the blob 400 is signed, the image size block 406 includes information associated with the size of the signed blob 400.

The authentication and encryption metadata block 408 includes information related to the authentication, decryption, and authorization of the blob 400 after it is received as an OTA update by the system-on-chip 110. For example, the authentication and authorization algorithms block 408 can include (i) authentication algorithms, (ii) encoding algorithms, (iii) a Key Encryption Key (KEK) index, (iv) an authentication key index, or (v) any combination of (i)-(iv). The authentication algorithms can be based on RSA-3072 or other suitable encryption standards. Once the blob 400 is authenticated, the system-on-chip 110 can use decryption standards such as AES-CTR-128 decryption to output a cleartext image.

In this example, a 128-bit key 412 is an encrypted key that is included in the blob 400. In this example, the encrypted key 412 is decrypted using AES with a Key Encryption Key (KEK) as determined by the KEK index. The KEK index may be included in the authentication and encryption metadata block 408. In some example configurations, the AES based encryption scheme may be AES-CTR-128. Longer keys may be used for greater security.

An initialization vector 414 is an initial input to the authentication and authorization algorithms. The initialization vector 414 can be used during the encryption and decryption process of a patch image blob 416. The initialization vector 414 can be used to provide an initial state to an encryption algorithm that is configured to encrypt the patch image blob 416. In some example embodiments, the patch image blob 416 may be larger than the size of the cryptographic key used to encrypt the patch image blob 416. A block cipher encryption process can be used. The patch image blob 416 may be divided into N blocks during the creation and packaging of the patch image blob 416 as an OTA update, and each block is encrypted separately. Accordingly, the initialization vector 414 may be used during the encryption process to help randomly or pseudo-randomly generate keys for the encryption of each block.

The patch image blob 416 includes the code and data characterizing the operations that the blob 400 is intended to augment the functionality of the boot ROM of the system-on-chip 110 with. For example, the patch image blob 416 can include the bytecode, binary code, assembly code, or other code that defines the functions that are intended to be used as an augmentation to the boot ROM of the system-on-chip 110. In some example embodiments, the patch image blob 416 may have a certain predetermined size. This size can be measured as a value of N words in the memory of the system-on-chip 110. The size of the patch image blob 416 is included in the RSA signature block 402 and/or the image size block 406 of the blob 400.

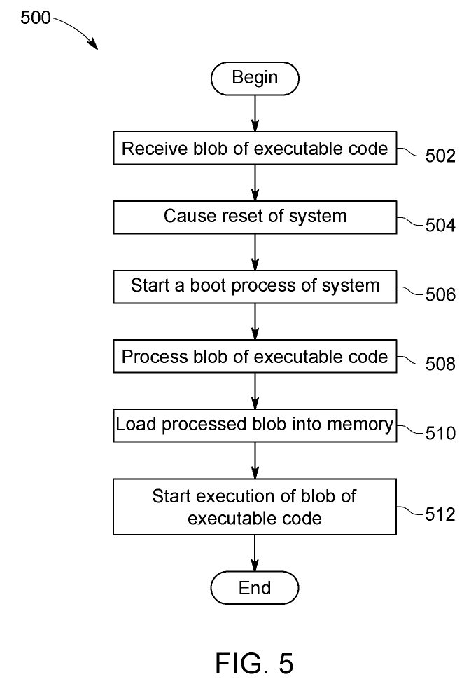

FIG. 5 is a flowchart showing an example method 500 of augmenting a boot ROM, according to certain aspects of the present disclosure. More specifically, FIG. 5 depicts example operations for receiving a blob of executable code, resetting the system, and loading the processed blob into the memory of the system.

At block 502, a blob of executable code is received. For example, an application running on the system-on-chip 110 can receive the blob via the over-the-air update infrastructure. The system-on-chip 110 may include security and identity components and functions as shown in FIG. 2. A control system such as the core processor 112 of the system-on-chip 110 may use the wireless interface 140 to receive the blob 400. In some embodiments, the blob 400 may include a signature block such as the Patch signature block 403 in FIG. 4 that is analyzed by the system-on-chip 110 to determine that the blob 400 is an OTA update.

At block 504, a reset of the system occurs. For example, the core processor 112 of the system-on-chip 110 can perform operations that cause the system-on-chip 110 to reset. The reset of the system-on-chip 110 may be caused based on the identification of the blob of executable code as an OTA update. For example, the system-on-chip 110 may identify the blob of executable code as an OTA updated based on the signature and reset the system based on that identification. In some examples, the system-on-chip 110 resets the system after setting up OTA infrastructure. In some example embodiments, the reset may also comprise a reset of the device or computing system that the system-on-chip 110 is operably coupled with.

At block 506, a boot process of the system is started. For example, the core processor 112 of the system-on-chip 110 may begin the execution of a boot process of the system-on-chip 110 after the reset process shuts off the system-on-chip 110. In some example configurations, the boot process may be a part of the reset process. In further example configurations, a signal received from the device may cause the system-on-chip 110 to start the boot process. The boot process may comprise executing a boot ROM of the system-on-chip 110 and/or the device that the system-on-chip 110 is operably coupled to. For example, the core processor 112 of the system-on-chip 110 may execute operations based on the instructions stored in the boot ROM. In some example configurations, the operations executed by the system-on-chip 110 and/or the device may be modified by the blob of executable code.

At block 508, the Secure Enclave Update blob is processed. For example, the core processor 112 of the system-on-chip 110 may execute operations that process the blob into a machine-executable format. The blob includes various blocks that characterize the blob, the instructions included in the blob, and identity, verification, encryption, and authentication features associated with the blob. For example, the blob may include signatures, public keys, and authentication functions that can be interpreted and executed by the core processor 112 of the system-on-chip 110. Based on these blocks, the blob is decrypted and its authenticity is verified. Processing the blob may also include identifying that the blob is associated with a function update to the boot ROM of the system-on-chip 110. This can be done by processing one or more keys and/or signatures associated with the blob to identify that the blob is associated with a function update to the boot ROM.

At block 510, the processed blob is loaded into memory. For example, the core processor 112 of the system-on-chip 110 may execute operations that load the processed blob into a memory of the system-on-chip 110. The memory of the system-on-chip 110 may be a volatile or nonvolatile memory. The memory may also be a volatile or nonvolatile memory of the device operably coupled with the system-on-chip 110. In some example configurations, the system-on-chip 110 includes a one-time-programmable (OTP) device such as the OTP 274. As described above, the OTP device is a device of the system-on-chip 110 that is capable of being programmed once and read afterwards. The blob can be loaded into the OTP device as a one-time event. In some example configurations, the blob includes entry functions that allow the boot ROM of the system-on-chip 110 to enter the memory and/or OTP device of the system-on-chip 110 during the boot process of the system-on-chip 110. This allows the core processor 112 of the system-on-chip 110 to access operations included in the blob of executable code during the boot process, expanding the functionality of the boot ROM.

At block 512 the blob of executable code is executed. For example, the blob of executable code may include instructions that are readable by the core processor 112 of the system-on-chip 110. These instructions can be stored in the patch image blob block of the blob of executable code. Likewise, the blob of executable code may include keys, signatures, algorithms, and authentication features that are readable by the core processor 112 of the system-on-chip 110. The core processor 112 of the system-on-chip 110 reads the instructions of the blob of executable code and performs operations based on the instructions. The execution of the blob of executable code can be integrated into the ongoing boot process of the system-on-chip 110 and/or the device 100.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

Each of these embodiments and obvious variations thereof is contemplated as falling within the spirit and scope of the claimed invention, which is set forth in the following claims.

What is claimed is:

1. A system-on-chip comprising:
a boot read only memory (ROM) including executable boot code; and
a secure enclave storing a blob of executable code downloaded to the system-on-chip and accessible to at least one processor of the system-on-chip when the executable boot code of the boot ROM is executed by the at least one processor.

2. The system-on-chip of claim 1, wherein the blob is received by the system-on-chip via a wireless interface.

3. The system-on-chip of claim 1, wherein the blob is received by the system-on-chip via a wired interface.

4. The system-on-chip of claim 1, wherein the blob is encrypted and signed.

5. The system-on-chip of claim 1, wherein the blob of executable code is stored in static random access memory (SRAM).

6. The system-on-chip of claim 1, wherein the blob of executable code includes instructions that augment a function of the boot ROM when executed by the at least one processor.

7. The system-on-chip of claim 6, wherein the system-on-chip includes a one-time programmable (OTP) device, and wherein the blob of executable code is stored in the OTP as a one-time event.

8. The system-on-chip of claim 7, wherein the OTP device stores one or more trim values, and wherein the blob of executable code includes instructions to modify at least one of the stored trim values and augment a function of the boot ROM once when the boot ROM is executed by the at least one processor.

9. The system-on-chip of claim 6, wherein the boot ROM includes instructions that execute the blob of executable code to augment a function of the boot ROM each time the boot ROM is executed by the at least one processor.

10. The system-on-chip of claim 6, wherein the blob includes an entry function, and wherein the entry function accepts an input parameter.

11. The system-on-chip of claim 10, wherein the executable boot code of the boot ROM includes instructions to call the entry function and provide the input parameter to augment the functionality of the boot ROM.

12. A method comprising:
receiving, by one or more processors of a system-on-chip, a blob of executable code;
storing, by the one or more processors, the blob of executable code in a secure enclave of the system-on-chip;
causing a reset of the system-on-chip;
starting a boot process of the system-on-chip, the boot process including:
processing the blob of executable code; and
loading the processed blob into a memory of the system-on-chip as a library accessible by a boot read only memory (ROM) of the system-on-chip.

13. The method of claim 12, wherein the blob is received via a wireless interface.

14. The method of claim 12, wherein the blob is received via a wired interface.

15. The method of claim 12, wherein the blob is encrypted and signed.

16. The method of claim 15, wherein the processing of the blob of executable code further comprises:
decrypting the encrypted blob; and
verifying the decrypted blob.

17. The method of claim 12, further comprising:
checking, after a reset of the system-on-chip is started, and as part of an update checking protocol, for a presence of the blob of executable code.

18. The method of claim 12, wherein the execution of the boot ROM includes:
identifying, by one or more keys associated with the blob, if the blob is associated with a function update to the boot ROM.

19. The method of claim 12, wherein the blob includes an entry function, and wherein the execution of the boot ROM includes:
providing a first input parameter to the entry function of the processed blob to grant the library a superuser access to the system-on-chip; and
executing one or more functions included in the library.

20. The method of claim 19, wherein the execution of the boot ROM further includes:
upon a completion of the execution of one or more functions included in the library, performing a boot ROM exit, the exit including a cleanup of the memory of the system-on-chip where the blob is stored.
